(19) United States
(12) Patent Application Publication
(10) Pub. No.: US 2023/0169816 A1
(43) Pub. Date: Jun. 1, 2023

(54) APPARATUS AND METHOD FOR TRANSPORTATION OF FOODSTUFF

(71) Applicant: Picnic Works, Inc., Seattle, WA (US)

(72) Inventors: Timothy Talda, Seattle, WA (US); Kyu Han, Seattle, WA (US); Nicholas Spada, Seattle, WA (US)

(73) Assignee: Picnic Works, Inc., Seattle, WA (US)

(21) Appl. No.: 17/625,064

(22) PCT Filed: Apr. 12, 2021
(86) PCT No.: PCT/US21/26874

§ 371 Date: Jan. 5, 2022

(51) Int. Cl. G07F 9/10; A21B 3/07

(52) U.S. Cl. CPC G07F 9/105; A21B 3/07

(57) ABSTRACT

An automated system to transport foodstuff from at least a first location to at least a second location; where foodstuff comprises pizza dough or crust, cookies, breads, meats, vegetables, bowls, plates, take-away container, amongst others.

### CROSS-REFERENCES TO RELATED APPLICATIONS

This Application is a continuation of the U.S. application Ser. No. 16360487, filed on Mar. 21, 2019, and U.S. application Ser. No. 16360279, filed on Mar. 21, 2019; both applications are incorporated herein in their entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

Moving foodstuff in a commercial kitchen is labor intensive. For example, in a pizzeria setting, dough may be moved from a storage location to a pizza assembly location, to an oven, and to a location for serving. Timing is important. For example, putting a pizza into an oven later than expected or over or under-cooking pizza will cause customer service delays and food waste. A person moving foodstuff into or out of an oven, for example, may get burned. The risk of burn increases when a worker is under stress during busy production times, for example. Additionally, each time foodstuff is handled by a person, it may be contaminated by articles that should not be consumed. Automating movement of foodstuff in a commercial kitchen is difficult because different commercial kitchens have varying footprints and operational requirements are different.

### BRIEF DESCRIPTION OF INVENTION

An object of the automated system to transport foodstuff is to reduce labor cost.

Another object of the automated system to transport foodstuff is to reduce customer service delays or errors.

Another object of the automated system to transport foodstuff is to reduce contamination of foodstuff.

Another object of the automated system to transport foodstuff is to reduce risk of injury in commercial kitchens.

Another object of the automated system to transport foodstuff is to provide a system that supports different footprints and operational needs.

### DESCRIPTION OF THE SEVERAL VIEWS OF THE DRAWINGS

The following detailed description will be better understood when read in conjunction with the appended drawings, in which there are shown in the drawings example embodiments for the purposes of illustration. It should be understood, however, that the present disclosure is not limited to the precise arrangements and instrumentalities shown. In the drawings:

FIG. 1 is an embodiment of a system to transport foodstuff;

FIG. 2A is an embodiment of a system to transport foodstuff;

FIG. 2B is an embodiment of a system to transport foodstuff;

FIG. 3 is an embodiment of a system to transport foodstuff;

FIG. 4 is an embodiment of a system to transport foodstuff.

### DETAILED DESCRIPTION OF THE INVENTION

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Described herein is an automated system for transporting foodstuff (“foodstuff transport”) (100). Foodstuff may include food items such as pizza dough or crust, cookies, breads, meats, vegetables, amongst others; or items that hold foodstuff such as bowls, plates, take-away container, amongst others. For ease of description, the foodstuff transport (100) is shown and described as a rectangle of square; and its movement is discussed in linear coordinated. However, the frame may be any shape; and using same or similar components can deliver foodstuff from a first location to a second location. In a particular embodiment, the frame may be in the shape of a circle or a semi-circle, or a sphere or semi-sphere.

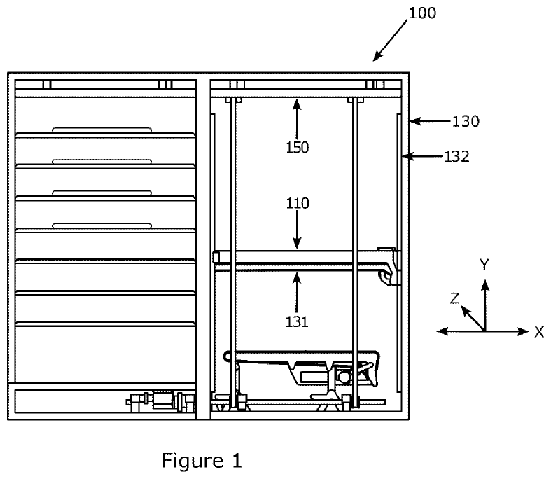

Referring to FIGS. 1, 2A, 2B, and 3, in an embodiment, the foodstuff transport (100) is comprised of at least one tray (110) which is operably attached to a guide rail system (130). The guide rail system (130) is comprised of at least one horizontal guide rail (131) and at least one vertical guide rail (132). A guide rail is a device or mechanism that directs objects through a channel. In one embodiment, a guide rail is comprised of at one least cog or wheel that is operably mated to a tray (110) and moves along a frame that defines a channel. (channel and cog or wheel not shown) The guide system (130) is supported within a frame (150).

In an embodiment, the tray (110) is comprised of a motor and pulley system (not shown), or other mechanism, that enables the tray (110) to move along the vertical guide rail (i.e., along the y-axis) (132); and allows the tray (110) to extend outside the parameters of the frame (150) in the horizonal (x-axis) direction along the horizontal guide rail (131). Movement of the tray (110) along the x-axis and outside and back to the parameters of the frame (150) is shown by directional arrows A1 and A2.

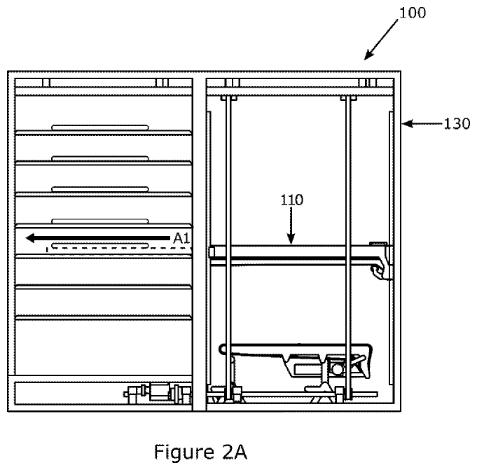

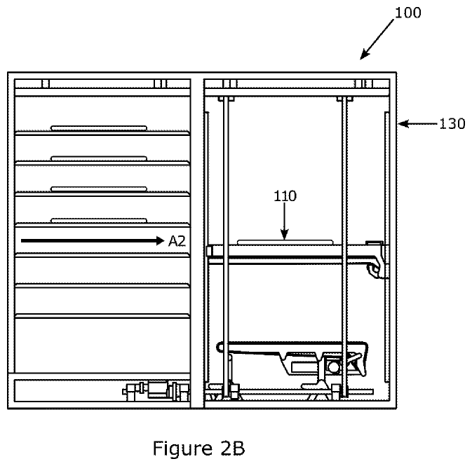

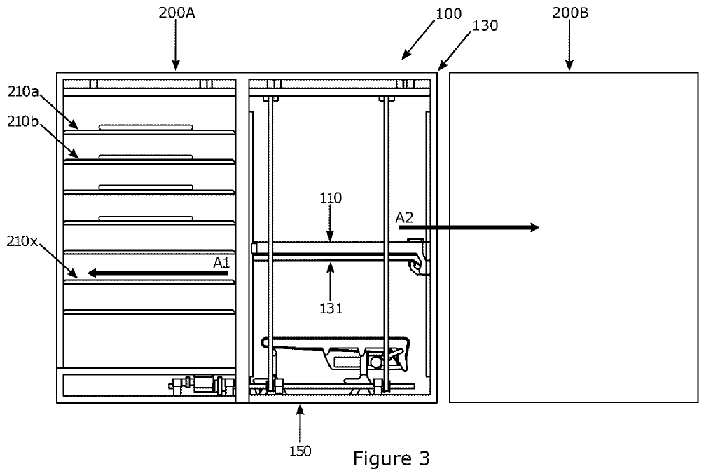

Referring to FIGS. 2 and 3, in a method to use the foodstuff transport (100), the foodstuff transport (100) may be operably located near a least a first unit that holds or stores foodstuff (“storage unit”) (200A). Storage unit (200A) may be a refrigerator, pantry or other storage unit, or oven, amongst others. In one embodiment, the storage unit (200A) has similar shape and dimensions as the foodstuff transport (100). For exemplary purposes, the storage unit (200A) having a plurality of shelves (210a, 210b, . . . 210x) is shown. In an embodiment, operably located near a storage unit means that the foodstuff transport (100) is located close enough to a shelf (210) so that the tray (110) may extend outside the frame (150), along the x-axis, so that the tray (110) may receive or deposit foodstuff from or to shelf (210) and retreat into the frame (150). The tray (110) may travel along the vertical guide rail (132), y-axis, extend outside the frame (150), along the x-axis, to receive food stuff from one or multiple shelves or selected shelves (210).

Referring to FIG. 3, in some embodiments, the foodstuff transport (100) may be operably located near more than one storage unit. Here, the tray (110) may extend as shown by A1 and A2 to retrieve and/or deposit foodstuff into multiple storage units (200A, 200B).

In one embodiment, the first storage unit (200A) has a plurality of shelves; where each shelf holds a pizza crust. The second storage unit (200B) is an automated system or robot that associates pizza toppings (e.g., sauce, cheese, vegetables, meats, amongst others) with a pizza crust. Here, each shelf of storage unit 200A may hold a different type of crust (e.g., wheat, thin, thick, partially cooked, frozen), for example. The assembled pizza may be delivered to an oven. A cooked pizza may be removed from the oven and delivered to a boxing station. In an embodiment, the movement of the tray (110) may be controlled remotely.

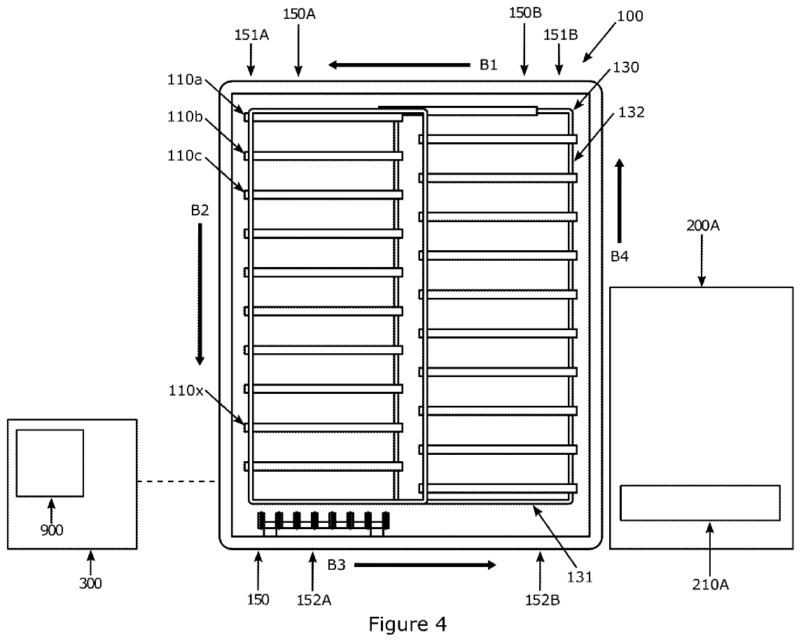

Referring to FIG. 4, in another embodiment, the foodstuff transporter (100) is comprised of a plurality of trays (110a, 110b, 110c . . . 110x); where each tray (110) is operably attached to a guide rail system (130) supported within a frame (150). A guide rail is a device or mechanism that directs objects through a channel. In one embodiment, a guide rail is comprised of at least one cog or wheel (not shown) that is operably mated to a tray (110) and moves along a frame that defines a channel. The frame (150) is configured so that the plurality of trays (110) are stacked in at least two columns (150A, 150B).

The guide rail system (130) is comprised of at least one horizontal guide rail (131) and one vertical guide rail (132). In an embodiment, each tray (110) is operably attached to at least one horizontal guide rail (131) and one vertical guide rail (132). The horizontal guide rail (131) allows each tray to move in a horizontal direction along the x-axis; movement shown as B1 and B3. In an embodiment, each column (150A, 150B) is comprised of at least one vertical guide rail (132).

The first column (150A) has a near end (151A) and a far end (152A); the second column (150B) has a near end (151B) and a far end (152B). When a tray (110) reaches the far end (152A), it is transferred, along a horizontal guide rail (131) to the second column (150B). Similarly, when a tray (110) reaches the near end (151B) of the second column (150B), it is transferred, along a horizontal guide rail (131) to the first column (150A). In this manner, the plurality of trays (110a, 110b, 110c . . . 110x) move as a carousel. It is understood that the carousel can move clockwise or counterclockwise.

In an embodiment, the tray (110) is comprised of a motor and pulley system (not shown), or other mechanism, that enables the tray (110) to move along the vertical guide rail (i.e., along the y-axis) (132); and allows the tray (110) to extend outside the parameters of the frame (150) in the horizonal (x-, y-axis) directions.

In a method to use the foodstuff transporter (100), the foodstuff transport (100) may be operably located near a first storage unit (200A). The first storage unit (200A) has at least one shelf (210A) that lies in the horizontal plane of at least one tray (110a, 110b, 110c . . . 110x). As the at least one tray (110a, 110b, 110c . . . 110x) rotates into position so that when the tray (110a, 110b, 110c . . . 110x ) extends outside the frame (150) along the x- or y-axis, it delivers foodstuff to the first storage unit (200A), and retreats into the frame (150), or vice versa. Each tray (110a, 110b, 110c . . . 110x) may be loaded with the same foodstuff or with different foodstuff.

A plurality of storage units (200A, 200B, 200C . . . 200X) may be stacked upon each other where more than one shelf lies in the horizontal plane of at least one tray (110a, 110b, 110c . . . 110x). The at least one tray (110a, 110b, 110c . . . 110x) rotates into position so that when the tray (110a, 110b, 110c . . . 110x) extends outside the frame (150) along the x- or y-axis, it delivers foodstuff to at least one shelf, and retreats into the frame (150), or vice versa. Each tray (110a, 110b, 110c . . . 110x) may be loaded with the same foodstuff or with different foodstuff.

In one embodiment, where at least a first storage unit (200A) is an automated system or robot that associates pizza toppings (e.g., sauce, cheese, vegetables, meats, amongst others) with a pizza crust. Here, each shelf may hold a different type of crust (e.g., wheat, thin, thick, partially cooked, frozen). The assembled pizza may be delivered to an oven. A cooked pizza may be removed from the oven and delivered to a boxing station.

The tray(s) (110) may be or any shape or size that allows for transfer of foodstuff to or from the tray(s) (110). In some embodiments, the tray(s) (110) may be heated, cooled, or a combination thereof.

Referring to FIG. 4, in some embodiments, the foodstuff transporter (100) may be controlled by a controller (300). In an embodiment, the foodstuff transporter (100) communicates with a at least one controller (300) containing software (900) that controls the movement of trays (110) along the x-, y-, z-axis. In some embodiments, the controller (300) coordinates the movement of the trays (110) along the x-, y-, z-axis with the operations of an automated food assembly apparatus and/or cooking apparatus.

In an embodiment, at least a first tray (110a) holds a first type of foodstuff and at least a second tray (110b) holds a second type of foodstuff. Here, the controller (300) coordinates the movement of the trays (110a, 110b) along the x-, y-, z- axis to optimize delivery of foodstuff A and delivery of foodstuff B to the automated food assembly apparatus and/or cooking apparatus. In an embodiment, optimization means deliver foodstuff to the automated food assembly apparatus and/or cooking apparatus based on the length of time the foodstuff has been held on the foodstuff transporter (100). In an embodiment, optimization means selection of either the first type of foodstuff or the second type of foodstuff based on the demands of the automated food assembly apparatus and/or cooking apparatus.

As will be appreciated by one skilled in the art, aspects of the software may be embodied as a system, method, or computer product. Accordingly, aspects of the software may take the form of an entirely hardware embodiment, entirely software embodiment (including firmware, resident software, micro-code, etc.), or an embodiment combining software and hardware aspects. Further aspects of the software may take the form of a computer program embodied in one or more readable medium having computer readable program code/instructions thereon. Program code embodied on computer-readable medium may be transmitted using any appropriate medium, including but not limited to wireless, wireline, optical fiber cable, RF, etc., or any suitable combination of the foregoing. The computer code may be executed entirely on a user's computer; partly on the user's computer; as a standalone software package; a cloud service; partly on the user's computer and partly on a remote computer; or entirely on a remote computer, remote or cloud-based server. One skilled in the art will recognize the variety of alternative possibilities for the individual elements, and their arrangements, described above, while still falling within the spirit of the invention. Further, while the above describes several embodiments of the invention used primarily in connection with making pizza, those skilled in the art will appreciate that there are a number of alternatives that still fall within the spirit of our invention. Thus, it is to be understood that the invention is not limited to the embodiments described above, and that in light of the present disclosure, various other embodiments should be apparent to persons skilled in the art.

Accordingly, it is intended that the invention is not limited to the specific illustrative embodiments.

We claim as our invention:

1. An apparatus for transporting foodstuff is comprised of at least one tray which is operably attached to a guidance system; where the guidance system and tray are supported within a frame; where the guidance system allows the tray to extend outside the frame and along the frame.

2. The apparatus for transporting foodstuff of claim 1 is further comprised of a controller.

3. The apparatus for transporting foodstuff of claim 2 whereby the controller optimizes the delivery of foodstuff from the tray to a foodstuff assembly apparatus or a foodstuff cooking apparatus.

4. The apparatus for transporting foodstuff of claim 3 whereby optimizing means delivering foodstuff based on the period of time it has been held on the tray.

5. The apparatus for transporting foodstuff of claim 3 whereby optimizing means delivering foodstuff to the foodstuff assembly apparatus and/or foodstuff cooking apparatus based on the output requirement of the foodstuff assembly apparatus or foodstuff cooking apparatus.

6. The apparatus for transporting foodstuff of claim 1 where foodstuff comprises pizza dough or crust, cookies, breads, meats, vegetables, bowls, plates, take-away container.

7. A method to use an apparatus for transporting foodstuff is comprised of at least one tray which is operably attached to a guidance system; where the guidance system and tray are supported within a frame; where the guidance system allows the tray to extend outside the frame and along the frame comprises operably locating the system for transporting foodstuff near a storage unit.

8. The method of claim 7 where the storage unit may be an oven, pantry, refrigerator, storage location, a foodstuff assembly apparatus and/or a foodstuff cooking apparatus.

9. The method of claim 7 where foodstuff companies pizza dough or crust, cookies, breads, meats, vegetables, bowls, plates, take-away container.

10. An apparatus for transporting foodstuff is comprised of at least one frame that defines at least a first column and a second column; where a plurality of trays is supported within the frame; where each tray is operably attached to a guidance system; where the guidance system allows each tray to transverse from the first column to the second column; where the guidance system allows each tray to extend outside of the frame.

11. The apparatus for transporting foodstuff of claim 10 is further comprised of a controller.

12. The apparatus for transporting foodstuff of claim 10 where foodstuff is delivered, from at least one tray, to a foodstuff assembly apparatus or a foodstuff cooking apparatus, based on time.

13. The apparatus for transporting foodstuff of claim 12 where optimizing means delivering foodstuff based on the period of time it has been held on the tray.

14. The apparatus for transporting foodstuff of claim 10 where foodstuff is delivered to the foodstuff assembly apparatus or foodstuff cooking apparatus based on the output requirement of the foodstuff assembly apparatus or foodstuff cooking apparatus.

15. The apparatus for transporting foodstuff of claim 10 where at least a first tray holds a first foodstuff and at least a second tray holds a second foodstuff; where where either the first foodstuff or the second foodstuff is selected to be delivered to a foodstuff assembly apparatus and/or a foodstuff cooking apparatus.

16. The apparatus for transporting foodstuff of claim 10 where foodstuff is comprised of pizza dough or crust, cookies, breads, meats, vegetables, bowls, plates, take-away container.

17. A method to use an apparatus for transporting foodstuff is comprised of at least one frame that defines at least a first column and a second column; where a plurality of trays is supported within the frame; where each tray is operably attached to a guidance system; where the guidance system allows each tray to transverse from the first column to the second column; where the guidance system allows each tray to extend outside of the frame comprises operably locating the apparatus for transporting foodstuff near a storage unit.

18. The method of claim 17 to use the apparatus for transporting foodstuff where the storage unit may be an oven, pantry, refrigerator, storage location, a foodstuff assembly apparatus and/or a foodstuff cooking apparatus.

19. The method of claim 17 where the apparatus for transporting foodstuff is further comprised of a controller.

20. The method of claim 18 where at least a first tray holds a first type of foodstuff and a second tray holds a second type of foodstuff; where movement of the first tray and the second tray along the x-, y-, z- axis is optimized to deliver of the first type of foodstuff and deliver the second type of foodstuff to the automated foodstuff assembly apparatus and/or a foodstuff cooking apparatus.

21. The method of claim 20 where optimized means deliver foodstuff to an automated foodstuff assembly apparatus and/or a foodstuff cooking apparatus based on the length of time the foodstuff has been held on the foodstuff transporter.

22. The method of claim 20 where optimized means deliver foodstuff to an automated foodstuff assembly apparatus and/or a foodstuff cooking apparatus based on the output requirements of the automated foodstuff assembly apparatus and/or a foodstuff cooking apparatus.

23. The method of claim 17 where foodstuff is comprised of pizza dough or crust, cookies, breads, meats, vegetables, bowls, plates, take-away container.
